(19) United States
(12) Patent Application Publication
(10) Pub. No.: US 2005/0178342 A1
(43) Pub. Date: Aug. 18, 2005

(54) Animal exercise and amusement device

(76) Inventor: Elizabeth Kenny, Flossmoor, IL (US)

Correspondence Address: GREENBERG TRAURIG, P.C.;Suite 2500, 77 West Wacker Drive, Chicago, IL, 60601-1273, US

(21) Appl. No.: 10/777,510

(22) Filed: Feb. 12, 2004

(51) Int. Cl. A01K 29/00; A01K 15/02

(52) U.S. Cl. 119/708

(57) ABSTRACT

An animal exercise and amusement device for pets, particularly cats, for enabling a pet owner to interact with a pet without requiring the use of hands and enabling interaction without continuous active attention by the owner. The device includes a passive attachment device, and an amusement teaser, which is tethered to the passive attachment device. The tether may be of fixed length, or it may be elastic in nature.

### BACKGROUND OF THE DISCLOSURE

1. Field of the Invention

The present invention relates in general to devices for providing exercise and amusement for animals, particularly house pets, and even more particularly, kittens and cats.

2. Background Art

Devices for providing exercise and amusement for animals have existed for many years, perhaps as long as man has had domesticated animals for pets. Certain such domesticated “pet” animals are particularly active by nature, and can derive benefit from an outlet for expending excess energy. Dogs and cats, especially cats, when left on their own, can become inquisitive and can disturb household articles and furnishings, in the process of expending excess energy and dissipating restlessness. Such animals (and their owners) can derive benefit from the animals' use of exercise and amusement devices.

Such exercise devices may often be in the form of statically suspended decorated objects, typically made to look like something that the particular animal might be curious about or attracted to, such as a bone or ball (dogs), or a bird or fish (cats). The objects typically may be suspended from a fixed position higher than the animal can reach from floor level, with a cord or string holding the actual object at a height near to or above the normal reach of the animal's paws. Alternatively, the object may be suspended by a cord, the far end of which is attached to a rod or shaft, the base of which may be at floor level or any other suitable location. The goal of the device is to attract, by its appearance, the animal's attention, causing the animal to swipe at the object. Contact with the object will cause it to swing and bounce about, further capturing the animal's attention, and causing it to further “chase” the now-moving object.

Such devices are disclosed in de Bruler, U.S. Pat. No. 2,194,736; Tae-Ho, U.S. Pat. No. 4,712,510; Matthews, U.S. Pat. No. 5,111,771; Krietsman et al., U.S. Pat. No. 5,474,032; Krietzman et al., U.S. Pat. No. 5,829,391; and Renforth et al., U.S. Pat. No. 6,318,300 B1.

While these “static” devices can be useful for providing periods of amusement to the animals, because they are tethered to a fixed base, there is a certain amount of limitation to the spontaneity and variety of activity that these devices can provide. Additionally, they lack interaction with humans, which domesticated household pets require for health and behavioral stability.

Accordingly, further exercise and amusement devices have been created that involve human interaction with the pet. Typically such devices involve replacing the fixed support for the tether with a handle, wand or the like, to be brandished by the pet owner or other human. Such devices enable a pet to interact with “its” human, enhancing the amusement experience and providing additional variability in the activity.

References that disclose such devices include Ament, U.S. Pat. No. 2,307,905; Galkiewicz, U.S. Pat. No. 4,499,855; Takahashi et al., U.S. Pat. No. 5,357,904; and Hass, U.S. Pat. No. 5,961,406.

These references however, are configured to be hand-held by the human, and as such require continuous active attention and involvement by the individual. Recognizing that the amount of active attention that a person can provide to a pet is limited, it would be desirable to provide an animal exercise and amusement device which a person may employ that can provide such activity to an animal, while still providing a certain level of human interaction, without requiring continuous active attention on the part of the human.

It would further be desirable to provide an animal exercise and amusement device that not only provides exercise opportunities for the pet animal, but also enables the human pet owner to be mobile and engage in other activities, while simultaneously engaging in at least indirect interactive activity with the pet animal.

These and other desirable characteristics of the present invention will become apparent in view of the present specification, including claims, and drawings.

### SUMMARY OF THE INVENTION

The present invention comprises an animal exercise and amusement device, comprising a cuff, operably configured to be releasably affixed about a human limb; a tether, affixed at a first end thereof to the cuff; and a teaser, affixed to a second end of the tether.

In an embodiment of the invention, the cuff comprises a sack, containing weighting material, for providing an exercise component to movements of a human to whom the cuff is releasably affixed. The cuff may further comprise a fastening strap, affixed to the cuff, in which the fastening strap has a first looped end and a second free end, with cooperative fastening elements, affixed to a surface of the fastening strap, proximate the first looped end and the second free end thereof, respectively; and a buckle, captured by the first looped end of the fastening strap, whereby the cuff may be wrapped about a human limb, and releasably affixed by passing the second free end of the fastening strap through the buckle, and turned upon itself, to bring the cooperative fastening elements against one another in releasably fastening contact.

Alternatively, the cuff may comprise a thin, elongated web having opposed first and second ends, and opposed first and second surfaces; and cooperative fastening elements, one fastening element disposed on a first surface of the web at a first end thereof, and the other fastening element disposed on a second surface of the web at a second end thereof, whereby fastening of the cuff about a human limb is accomplished by wrapping the web about the limb, and directly bringing one of the cooperative fastening elements into direct contact with the other of the cooperative fastening elements, without folding or twisting the web.

The tether preferably may comprise an attachment portion, in the form of a loop, which encircles a portion of the cuff; and a teaser portion, which is affixed at a first end to the attachment portion, and further at a second end of which the teaser is affixed. Alternatively, the tether may comprise a single cord, affixed at its ends to the cuff and the teaser. In a preferred embodiment of the invention, at least a portion of the tether is fabricated from a stretchable material. Cooperative releasable fastener elements may be affixed to the tether and the teaser, so that the teaser may be removed from the tether and replaced by another teaser.

The teaser may have a shape that is at least one of ball-like, elongated, branched. Further, the teaser is preferably fabricated from at least one of: a smooth material, a rubbery material, a furry material, a feathery material, a fuzzy material, a spongy material. The teaser may be provided with a variety of depending objects of interest, each depending object of interest being at least one of: shiny, reflective, fluorescent, phosphorescent, transparent, translucent.

The invention may also include a wand member, interposed between the cuff and the tether, which includes at least one portion which has a level of resistance to bending which is greater than that of the tether. Further, a transition element may be provided, interposed between the wand member and the tether, which includes at least one portion which has a level of resistance to bending which is greater than that of the tether, but less than that of the at least one element of the wand member.

The present invention also comprises an animal exercise and amusement device, including a wand member; a transition element, extending from the wand member; a tether, extending from the transition element; and a teaser, affixed to the tether. The wand member preferably includes at least one portion which has a level of resistance to bending which is greater than that of the tether, and the transition element preferably includes at least one portion which has a level of resistance to bending which is greater than that of the tether, but less than that of the at least one element of the wand member.

### BRIEF DESCRIPTION OF THE DRAWINGS

FIG. 1 is a view of an animal exercise and amusement device according to one embodiment of the invention.

FIG. 1A is a view of a cuff for the animal exercise and amusement device according to the embodiment of FIG. 1, shown in its open configuration.

FIG. 2 is another view, from another perspective, of the animal exercise and amusement device according to the embodiment of FIG. 1.

FIG. 3 is yet another view, from still another perspective, of the animal exercise and amusement device according to the embodiment of FIG. 1.

FIG. 4 is a view of an animal exercise and amusement device according to another embodiment of the invention.

FIG. 5 is another view, from another perspective, of the animal exercise and amusement device according to the embodiment of FIG. 4.

FIG. 6 is yet another view, from still another perspective, of the animal exercise and amusement device according to the embodiment of FIG. 4.

FIG. 7 is a view of an alternative embodiment of the invention, in which a substantially rigid pole is interposed between the cuff and the tether.

FIG. 8 is a fragmentary view of an end of a tether, which is provided with a releasable fastener clip.

FIG. 9 is a view of another alternative embodiment of the invention.

### DETAILED DESCRIPTION OF THE INVENTION

While this invention is susceptible of embodiment in many different forms, there is shown in the drawings and will herein be described in detail, a preferred embodiment with the understanding that the present disclosure should be considered as an exemplification of the principles of the invention and is not intended to limit the invention to the embodiment so illustrated.

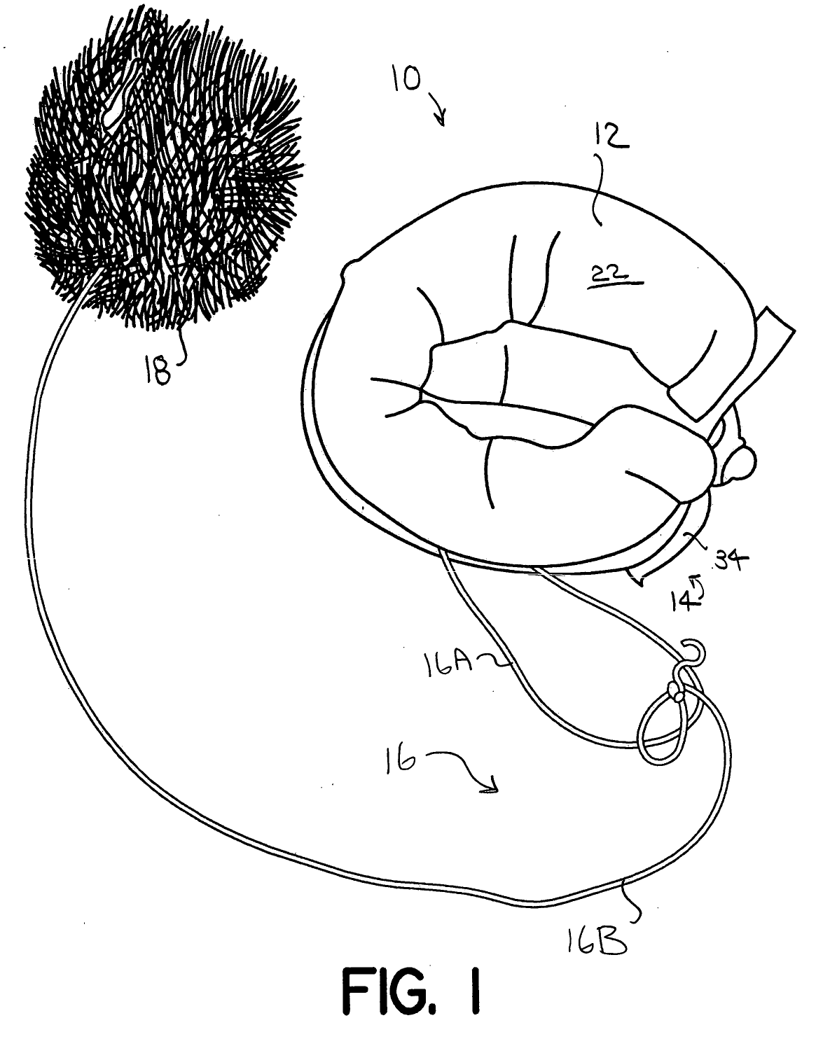

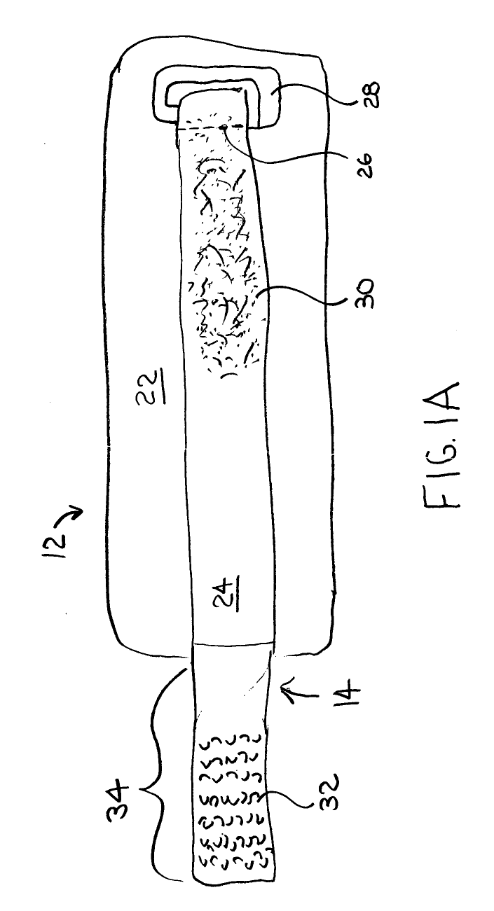

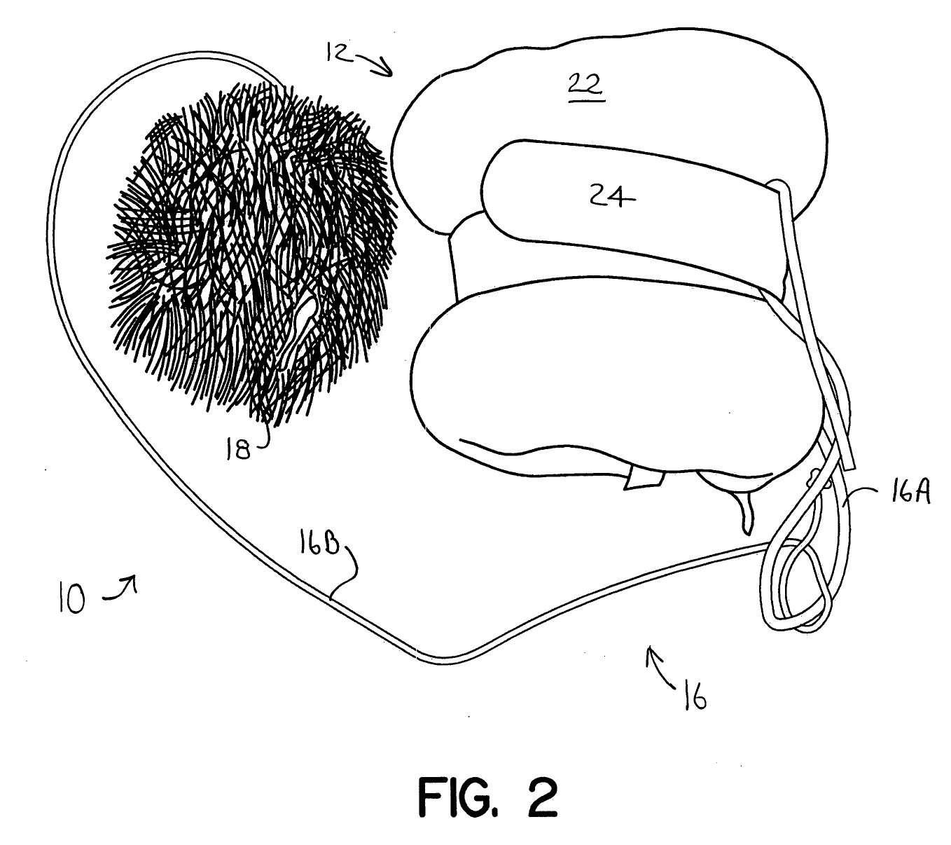

Animal exercise and amusement device 10, according to one embodiment of the invention, is shown in FIGS. 1-3. Device 10 includes cuff 12, fastener strap 14, tether 16, and teaser 18. Cuff 12 is intended to be placed in an encircling fashion about an ankle or leg, or arm or wrist, and is shown in its open configuration in FIG. 1A. Cuff 12 includes body 20, which may be preferably formed as a sack or enclosure 22, made from any suitable fabric or plastic material that will be comfortable and non-irritating to human skin, and filled with weighting material (sand or the like) so that cuff 12 acts as an exercise ankle (or arm) weight for the human. Alternatively, cuff 12 may be filled with any suitable padding or filling material, if additional weight is not desired.

Strap 14 comprises ribbon 24, again formed from any suitable material, which is affixed along a mid-portion thereof, to the sack portion 22 of cuff 12. One end of ribbon 24 is formed into a loop, e.g., by stitching 26 (which may be augmented or replaced by any other suitable fastening method, such as glue), to encircle one bight of buckle 28. Strap 14 additionally includes cooperating fastening elements such as loop elements 30 distributed on one side of ribbon 24, and hook elements 32, which are located on the same side, opposite free end 34 of ribbon 24. Fastening of cuff 12 about an ankle or arm is accomplished by wrapping sack 22 about the limb portion, until the opposing ends of sack 22 are brought into proximity with one another, passing free end 34 of ribbon 24 through buckle 28, and then drawing free end 34 of ribbon 24 upon itself and against the loop elements 30, as shown in FIGS. 1, 2 and 3.

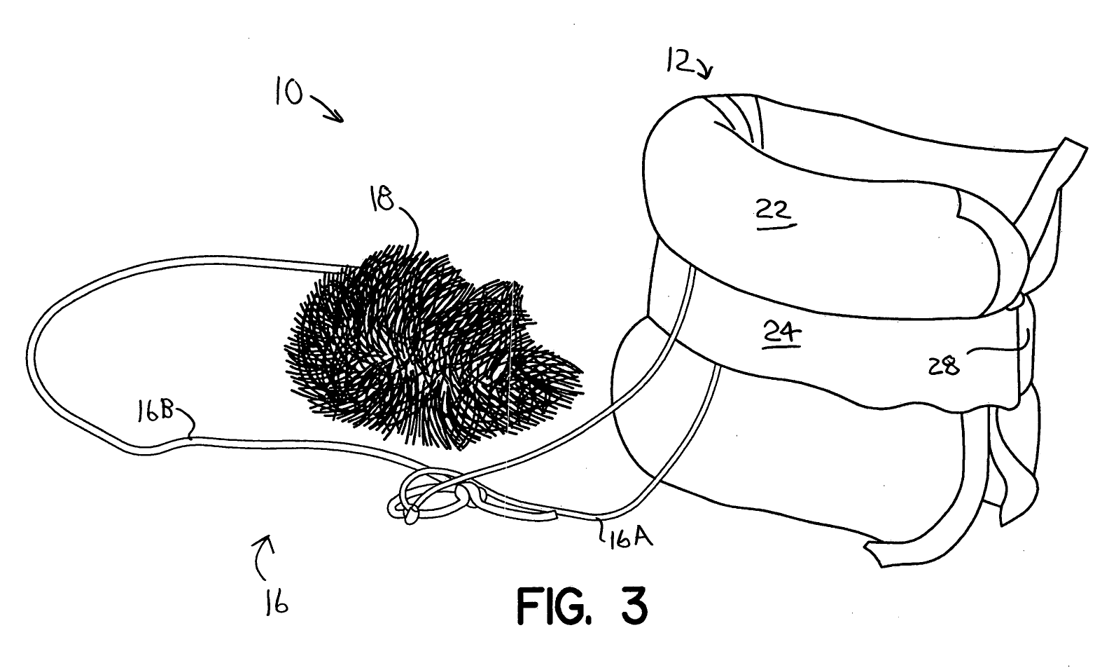

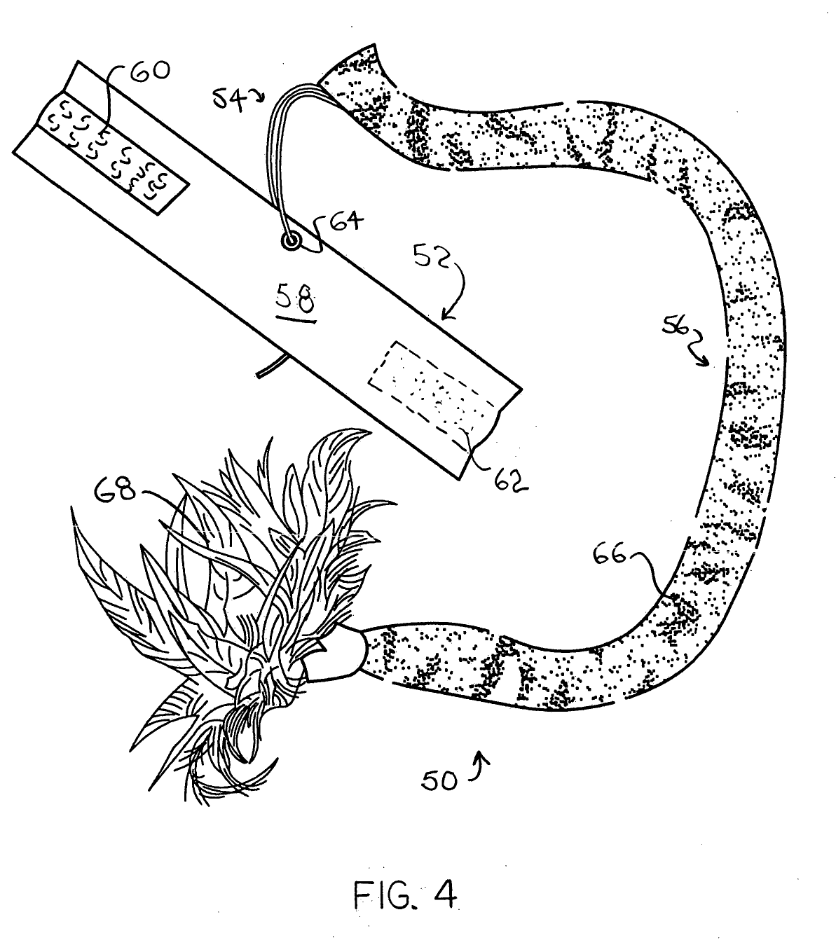

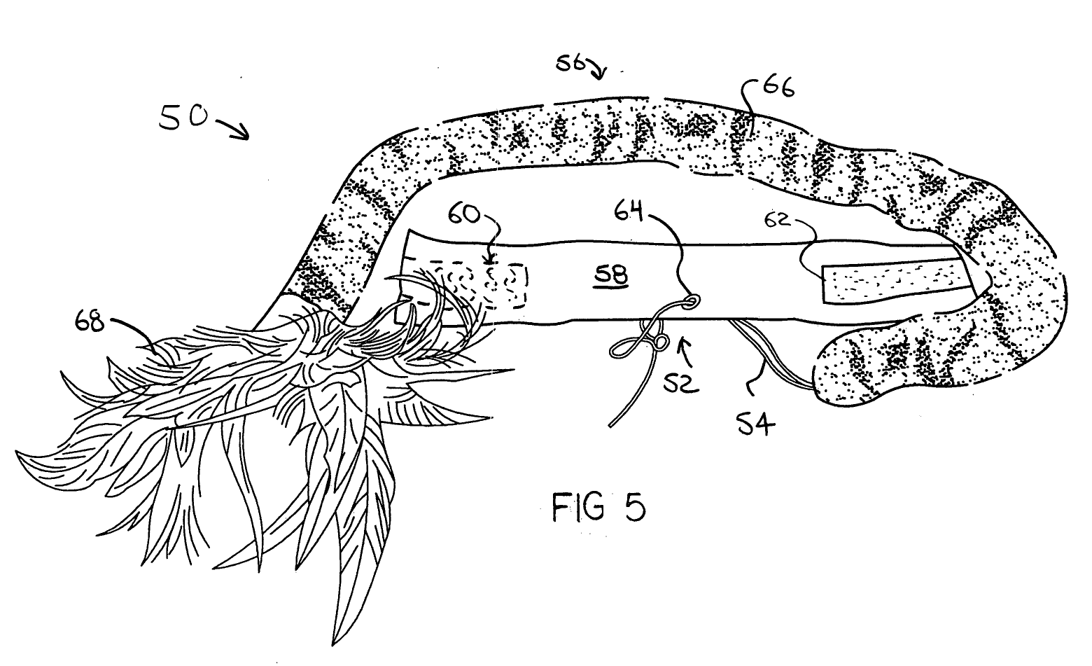

Tether 16, which may be a single contiguous element, or alternatively, as shown, comprised of attachment portion 16A, and teaser portion 16B, is affixed to cuff 12, in an embodiment of the invention, by simply looping attachment portion 16A of tether 16 around free end 34 of strap 24, and knotting it securely, and then tying teaser portion 16B to attachment portion 16A. Alternatively, tether 16 may be permanently affixed to cuff 12 by any suitable means such as by stitching, gluing, threading it through eyelets (not shown) formed in sack 22, etc., or any combination thereof. Preferably, tether 16 is fabricated from a fiber or plastic cord material that has an ultimate tensile strength greater than a pet can be expected to exert, and not readily chewed through by an animal. In addition, tether 16 may be capable of limited stretching, to provide additional amusement action to the movement of the teaser 18. Alternatively, instead of being a cord, the tether may be formed as a teaser in itself, for example, in the form of a furred or feathery boa (such as shown with respect to the embodiment of FIGS. 4-6). In alternative embodiments, a plurality of strands may be employed, either in parallel, and/or in series, to form the tether, as may be desired.

Teaser 18 may be, as shown in the embodiment of FIGS. 1-3, a ball of fur (fake or real), or any other object of a suitable shape, configuration, material and appearance as would be attractive or interesting to the type of animal with which device 10 is intended to be used. The teaser may be a ball-like member, fabricated from at least one of a smooth material, a rubbery material, a furry material, a fuzzy material, a spongy material. Alternatively, the teaser may be an elongated or branched member, having a variety of depending objects of interest, that may be shiny, reflective, fluorescent, phosphorescent, transparent, translucent, etc.

Once device 10 has been attached to, typically, an ankle of an individual, that individual is then free to walk about (in a home, for example), with the teaser bouncing back and forth as a result of the leg movements. The pet (e.g., a cat) will see this continuously moving object, and become interested, and hopefully, attempt to pouncing upon and grab the teaser, which, even if caught, will be pulled from the animal's grasp, if the human continues to walk or move about. Presumably, the pet will not be of sufficient size and strength that a human (even a small child) will be arrested in their movements or knocked down, should the animal obtain a firm grip upon the teaser 18 or the tether 16.

An alternative embodiment of the invention is illustrated in FIGS. 4-6. Device 50 includes cuff 52, tether 54 and teaser 56. Cuff 52 comprises a relatively thin (in the sense of thickness) web 58 (which may be fabricated from natural fiber, synthetic material or a combination thereof), which has cooperative fastening elements thereof, for example, hook elements 60 (on the side facing the observer of FIG. 4) and loop elements 62 (on the opposite side of web 58 and shown in broken lines). Attachment of cuff 50 is a simple matter of wrapping web 58 about the limb, and bringing loop elements 62 into contact with hook elements 60, and pressing them together, in the usual method of using such a fastening.

Tether 54, in this embodiment, is a length of cord or string, of any suitable material (which may be stretchable), that is passed through an opening (e.g., eyelet 64) in web 58, and knotted, so as to form a tether having two effective strands. Alternatively, a knot or any other suitable affixation method may be employed, to result in a single strand tether.

The opposite “end” of tether 54 is attached to teaser 56. Teaser 56 in this embodiment is in the form of a length of furred or fuzzy material 66, like a boa, which has, as a further attractive element, a feathery portion 68, which may be attached to the end of furred portion 66 by any suitable means.

The manner of play usage of device 50 of this embodiment is substantially the same as in the previously described embodiment, except that cuff 52 lacks the additional weight provided in cuff 12 of the first embodiment shown and described.

In each of the embodiments, the cuffs may be provided in different sizes, to enable both adults and children to use such devices.

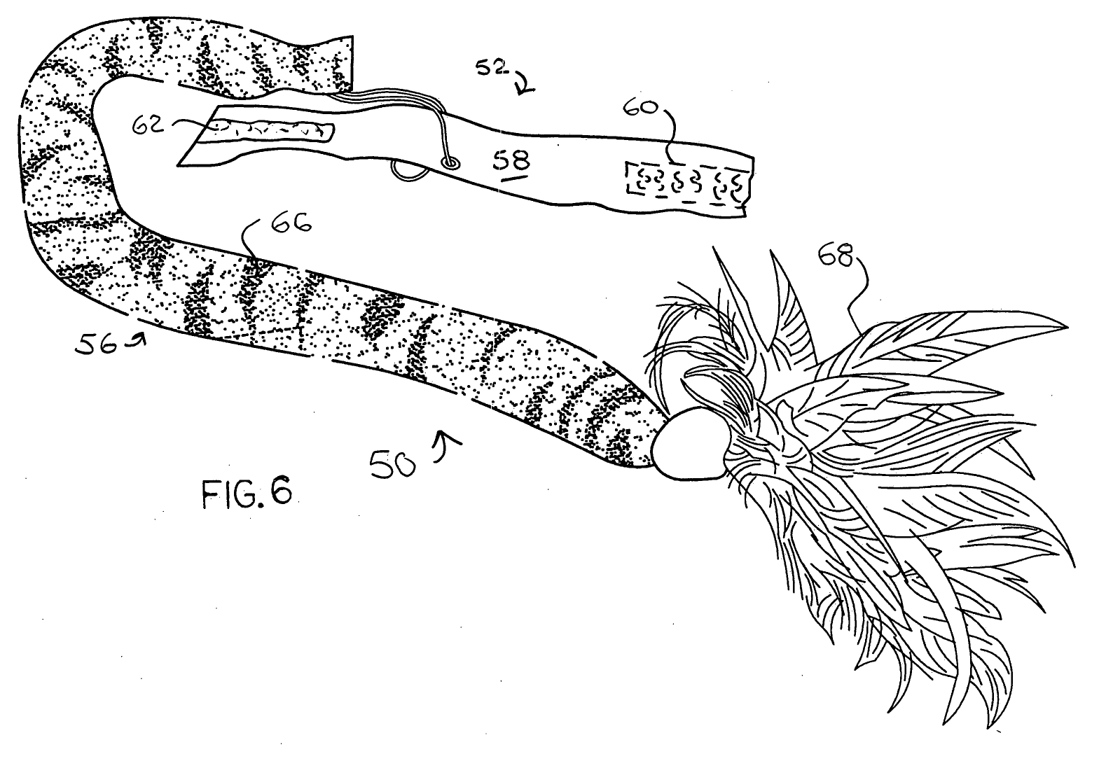

In alternate embodiments of the invention, a rigid or semi pole may be affixed to the cuff, as shown in FIG. 7, in such a manner that the pole 70 is maintained at a more or less perpendicular orientation relative to the limb to which the cuff is attached. This may be accomplished, for example, by having a base disk 72 received in between opposing layers (or restrained behind a single layer) of the cuff 74. Pole 70 may be fabricated from a plastic or fiberglass material that is slightly flexible, but tends to a straight self-supporting orientation when not under load. This enables the teaser 76, connected by tether 78, to be held at a stand-off distance from the limb, which may be desirable, for a pets that may still have claws or a tendency to nip when excited. To the “free” distal end of the pole, the tether is attached, in any suitable manner, and then the teaser.

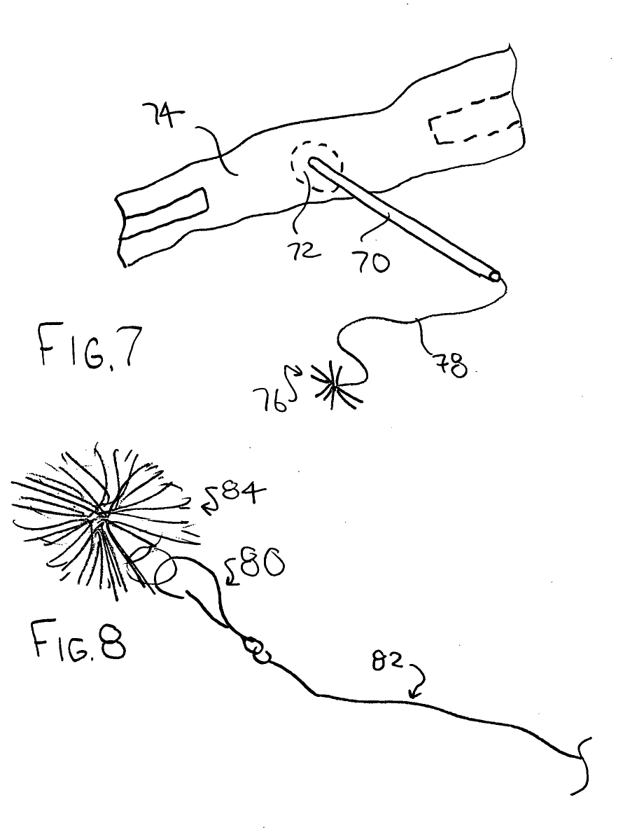

In still further embodiments of the invention, releasable clips 80 or other suitable releasable fasteners may be provided at one or both ends of the tether 82 (see, e.g., FIG. 8), to enable different types and styles of teasers 84 to be switched in and out, so that a variety of play modes are provided to maintain interest in the animal.

In the embodiments illustrated, the teasers are of the delicate variety favored by cats, but it is to be understood that, in alternative embodiments, more robust teasers (and tethers) may be employed for larger (or more rough playing) pets, such as dogs, ferrets, etc.

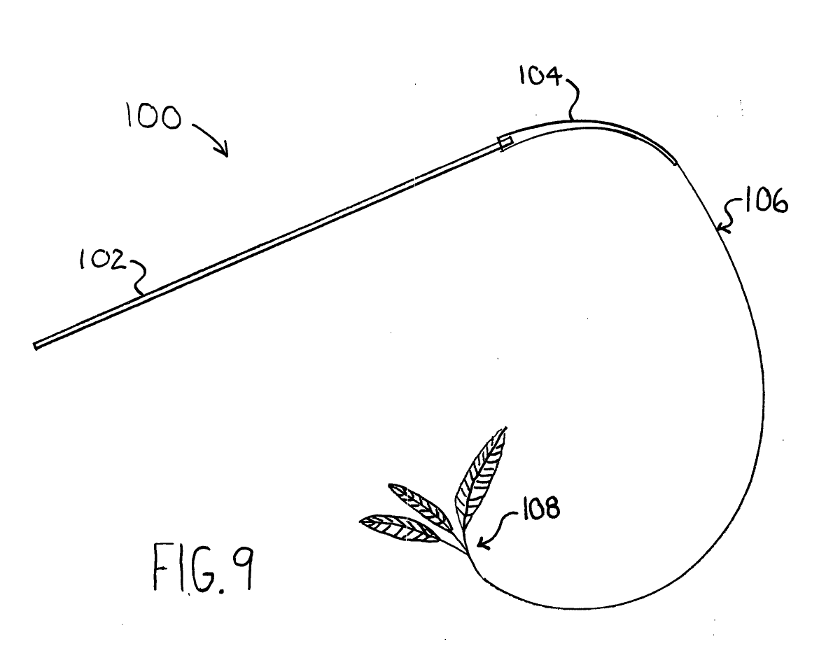

FIG. 9 illustrates an alternative embodiment of the invention (minus the cuff). Animal exercise and amusement device 100 includes an elongated wand 102, which may be fabricated from any suitable material, such as a relatively stiff plastic rod or tube. Connected to an end of wand 102 is transition element 104, which is a relatively shorter length of somewhat more flexible material, which may also be a length of plastic or rubber tubing, which is less resistant to bending, but does offer some resistance to bending. Extending from the end of transition element 104 is cord 106, which may be fabricated from an organic material such as cotton string, or preferably a polymeric material, that is highly flexible, yet resistant to breakage, fraying, chewing by an animal, etc. Cord 106 may be of a fixed length, or it may be made of a resilient, stretchable material, as described with respect to the previous embodiments. Teaser 108, shown in FIG. 9 as a grouping of feathers, is attached by tying, fasteners or adhesive or the like, to the end of cord 106, opposite to transition element 104. Animal exercise and amusement device 100 provides for improved “action” when in use in play with an animal, as the slightly flexible wand 102, and transition element 104 provide for more variable and interesting movements to be imparted to cord 106 and teaser 108. Although not shown in FIG. 9, it is to be understood that a relatively short-length wand 102 can be mounted to a cuff 74 as in the embodiment of FIG. 7, or to one of the other cuff configurations described herein, for an ankle or wrist mounted animal exercise and amusement device.

The foregoing description and drawings merely explain and illustrate the invention, and the invention is not so limited as those skilled in the art who have the disclosure before them will be able to make modifications and variations therein without departing from the scope of the invention.

1. An animal exercise and amusement device, comprising:
a cuff, operably configured to be releasably affixed about a human limb;
a tether, affixed at a first end thereof to the cuff; and
a teaser, affixed to a second end of the tether.

2. The animal exercise and amusement device, according to claim 1, wherein the cuff comprises:
a sack, containing weighting material, for providing an exercise component to movements of a human to whom the cuff is releasably affixed.

3. The animal exercise and amusement device, according to claim 2, wherein the cuff further comprises:
a fastening strap, affixed to the cuff,
the fastening strap having a first looped end and a second free end;
cooperative fastening elements, affixed to a surface of the fastening strap, proximate the first looped end and the second free end thereof, respectively; and
a buckle, captured by the first looped end of the fastening strap, whereby the cuff may be wrapped about a human limb, and releasably affixed by passing the second free end of the fastening strap through the buckle, and turned upon itself, to bring the cooperative fastening elements against one another in releasably fastening contact.

4. The animal exercise and amusement device, according to claim 1, wherein the cuff comprises:
a thin, elongated web having opposed first and second ends, and opposed first and second surfaces; and
cooperative fastening elements, one fastening element disposed on a first surface of the web at a first end thereof, and the other fastening element disposed on a second surface of the web at a second end thereof, whereby fastening of the cuff about a human limb is accomplished by wrapping the web about the limb, and directly bringing one of the cooperative fastening elements into direct contact with the other of the cooperative fastening elements, without folding or twisting the web.

5. The animal exercise and amusement device according to claim 1, wherein the tether further comprises:
an attachment portion, in the form of a loop, which encircles a portion of the cuff; and
a teaser portion, which is affixed at a first end to the attachment portion, and further at a second end of which the teaser is affixed.

6. The animal exercise and amusement device according to claim 1, wherein the tether comprises:
a single cord, affixed at its ends to the cuff and the teaser.

7. The animal exercise and amusement device according to claim 1, wherein at least a portion of the tether is fabricated from a stretchable material.

8. The animal exercise and amusement device according to claim 1, further comprising:
cooperative releasable fastener elements affixed to the tether and the teaser, so that the teaser may be removed from the tether and replaced by another teaser.

9. The animal exercise and amusement device, according to claim 1, wherein the teaser has a shape that is at least one of ball-like, elongated, branched.

10. The animal exercise and amusement device, according to claim 1, wherein the teaser is fabricated from at least one of: a smooth material, a rubbery material, a furry material, a feathery material, a fuzzy material, a spongy material.

11. The animal exercise and amusement device, according to claim 1, wherein the teaser is provided with a variety of depending objects of interest, each depending object of interest being at least one of: shiny, reflective, fluorescent, phosphorescent, transparent, translucent.
